(19) United States
(12) Patent Application Publication
(10) Pub. No.: US 2016/0234582 A1
(43) Pub. Date: Aug. 11, 2016

(54) Method and system for redundancy in a passive optical network

(71) Applicants: Daniel Ronald, Burnaby (CA); Byron Thom, Vancouver (CA); Stephen Chan, Burnaby (CA); Nine Siong Lam Hang, Richmond (CA); Pook-Ping Yao, Coquitlam (CA)

(72) Inventors: Daniel Ronald, Burnaby (CA); Byron Thom, Vancouver (CA); Stephen Chan, Burnaby (CA); Nine Siong Lam Hang, Richmond (CA); Pook-Ping Yao, Coquitlam (CA)

(21) Appl. No.: 15/040,811

(22) Filed: Feb. 10, 2016

Related U.S. Application Data
(60) Provisional application No. 62/114,269, filed on Feb. 10, 2015.

(51) Int. Cl. H04Q 11/00; H04L 12/24; H04B 10/032

(52) U.S. Cl. CPC H04Q 11/0067; H04B 10/032; H04L 41/0668; H04Q 2011/0081

(57) ABSTRACT

The present invention is related to redundancy within a passive optical network and may include a first optical line terminal (OLT), a second optical line terminal, a first optical networking terminal (ONT) including an optical port and at least one Ethernet port; and a first two-to-many passive optical splitter. In operation, the first ONT may be registered with the first OLT and the second OLT may have the transmit function of the first optical port turned off. The receive function of the first optical port on the second OLT may be turned on and may be listening to the communication between the first OLT and the first ONT. When the second OLT no longer receives a signal indicating that the first OLT is still registered with the first ONT, the second OLT may turn on the receive function of the first optical port and registers with the first ONT.

### CROSS-REFERENCE TO RELATED APPLICATIONS

This application claims the benefit of U.S. Provisional Patent Application No. 62/114,269 filed Feb. 10, 2015, the disclosure of which is incorporated by reference in its entirety.

### FIELD OF THE INVENTION

This invention is related to optical networking and in particular, redundancy in a passive optical network.

### BACKGROUND OF THE INVENTION

Passive optical networking (PON) is well known in the art to provide telecom services, such as video, voice and data. However, the use and requirements of telecom providers are very different than those of the enterprise. While telecom providers must are closed networks with very specialized and highly trained network engineers, enterprise users may run the gamut from knowledgeable to novices. Furthermore, building owners or operators may be concerned about network security in the PON deployments due to increased threats of placing network ports throughout a building. System uptime may also be a large concern.

A better paradigm for providing redundancy in a passive optical network is desired.

### SUMMARY OF THE INVENTION

The object of the invention is to provide an improved network topology including redundancy in passive optical networks.

In one aspect, the invention may reside in a networking data collector. The networking data collector may include a passive optical networking system and means for obtaining and storing network information from the at least one optical networking terminal. The PON system may include: at least one optical line terminal (OLT); a passive optical splitter; and at least one optical networking terminal (ONT).

In another aspect, the invention may reside in an analytics engine. The engine may include a passive optical network, means for collecting networking information from components in the passive optical network; identifying patterns in the network information; and notifying a user based on the patterns identified.

In another aspect, the present invention may reside in a networking data collector. The data collector may include: a passive optical networking system including: at least one optical line terminal (OLT); a passive optical splitter; and at least one optical networking terminal (ONT), means for obtaining and storing network information from the at least one optical networking terminal. The network information may, for each device at a particular ONT, include at least one of: destination address, source address, timing, amount of traffic, link-speed, timing, and traffic direction.

Alternately, the network information may include, for each device at a particular ONT, at least one of: return transit time (RTT), received signal strength indicators (RSSI), transmitted signal strength indicators (TSSI), current bias of the laser, temperature, and laser drift.

In another aspect, the present invention may reside in an analytics engine. The analytics engine may include: a passive optical network; means for collecting networking information from components in the passive optical network; identifying patterns in the network information; and notifying a user based on the patterns identified. In some embodiments, the pattern may be based on at least one of destination address, source address, timing, amount of traffic, link-speed, timing, and traffic direction. In other embodiments, the pattern may be based on PON parameters including at least one of return transit time (RTT), received signal strength indicators (RSSI), transmitted signal strength indicators (TSSI), current bias of the laser, temperature, and laser drift.

In some embodiments, the analytics engine creates a device signature for each device in the network. In other embodiments, the device signature may be based on heuristics over many devices of the same model or type or may be based on at least one of traffic profile, power profile and communication peers. In even further embodiments, the device signature may be based on the combination of traffic profile, power profile and communication peers.

In some preferred embodiments, the traffic profile may include the ratio of up/down traffic. Further, the analytics engine may identify a pattern for predicting a device failure. For example, the analytics engine may identify the pattern for device failure based on packet loss, timing. In some embodiments, the analytics engine may identify the pattern for device failure based on drifts in power consumption or based on a learning pattern of behaviour. In other embodiments, the pattern for device failure may be based on a combination of a learning pattern of behaviour and rules set by a device manufacturer. Similarly, the learning pattern may use at least one of heuristics and machine learning or may be selected from a change in MAC address, a change in power consumption, and a change in traffic profile. Alternately, in some embodiments the learning pattern may use at least one of time of day, seasonal changes, a weather almanac, business hours, and other forms of periodicity.

The pattern for a camera may change in response to commands sent to the camera. The command may be one of point, tilt, and zoom of the camera and may lead to changes in expected power consumption.

In a preferred embodiment, the analytics engine identifies a pattern for a network intrusion. Similarly, the analytics engine identifies a pattern for learning and tracking device behaviour over time.

Alternately, the analytics engine may identify a signature for every packet in the networking system. The analytics engine may identify a signature for every port in the networking system. The analytics engine may identify a signature for every device in the networking system. The analytics engine may identify a signature for every ONT in the networking system.

In yet another aspect, the invention may reside in a passive optical networking (PON) system implementing redundancy. Such a system may include a first optical line terminal (OLT), a second optical line terminal, a first optical networking terminal (ONT) including an optical port and at least one Ethernet port; and a first passive optical splitter. The first and the second OLT may include at least one Ethernet port and a first optical port having a transmit function and a receive function.

The passive optical splitter may include a first optical input optically coupled to the first optical port of the first OLT, a second optical input optically coupled to the first optical port of the second OLT, and a plurality of optical outputs, wherein a first optical output is optically coupled to the optical port of the first ONT.

In operation, the first ONT may be registered with the first OLT and the second OLT may have the transmit function of the first optical port turned off. The receive function of the first optical port on the second OLT may be turned on and may be listening to the communication between the first OLT and the first ONT. When the second OLT no longer receives a signal indicating that the first OLT is still registered with the first ONT, the second OLT may turn on the receive function of the first optical port and registers with the first ONT.

In yet another aspect, the present invention may reside in a passive optical networking (PON) system for implementing redundancy. The system may include a first optical line terminal (OLT) including at least one Ethernet port; a first optical port having a transmit function and a receive function; a second optical line terminal (OLT) including at least one Ethernet port; a first optical port having a transmit function and a receive function; a first optical networking terminal (ONT) including an optical port and at least one Ethernet port; a first passive optical splitter including: a first optical input optically coupled to the first optical port of the first OLT; a second optical input optically coupled to the first optical port of the second OLT; and a plurality of optical outputs, wherein a first optical output is optically coupled to the optical port of the first ONT; and wherein the first OLT cannot directly communicate with the second OLT through the first passive optical splitter. In operation, the first ONT is registered with the first OLT and the second OLT has the transmit function of the first optical port turned off, but the receive function turned on and is listening to the communication from the first ONT to the first OLT. When the second OLT no longer receives a signal indicating that the first OLT is still registered with the first ONT, the second OLT turns on the receive function of the first optical port and registers with the first ONT to allow the flow of traffic from the first ONT to the second OLT.

In yet another aspect, the present invention may reside in a state machine for implementing redundancy in a passive optical network. The passive optical network may include an optical line terminal (OLT) with multiple optical channels. The state machine includes an ACTIVE state, a PROTECT state and a STANDBY state. The ACTIVE state allows the OLT to register with at least one optical line terminal (ONT) and to pass traffic with the at least one ONT under normal operation.

The PROTECT state continuously monitors the RSSI of the at least one ONT connected to a different OLT in the ACTIVE state, where in the OLT in the PROTECT state has disabled its transmit capabilities and has enabled its receive capabilities.

Finally, the STANDBY state is used after initial STARTUP to ensure that the OLT does not immediately shine a laser and interfere with the different OLT in the ACTIVE state.

In yet another aspect, the present invention resides in a method for implementing redundancy in a passive optical network. The method may include optically coupling a first optical line terminal (OLT) and a second OLT to at least one optical networking terminal (ONT) through a two-to-many passive optical splitter. The first OLT may be optically coupled to the first input of the passive optical splitter and the second OLT may be optically coupled to the second input of the passive optical splitter, with traffic passing from the at least one ONT through the first OLT. The method may also include disabling the transmit function and enabling the receive function on the optical port of the second OLT. The method may also include monitoring the received signal strength indicator (RSSI) on the second OLT to create a takeover signal if the link between the at least one ONT and the first OLT is disconnected. The method may also include enabling the transmit function on the optical port of the second OLT and registering the second OLT with the at least one ONT on receipt of the takeover signal. The method may also include enabling the second OLT to takeover the role of passing traffic with the at least one ONT, from the first OLT; and the method may also include passing the traffic from the at least one ONT through the second OLT after the successful completion of the takeover.

Other devices, methods and machine-readable media are also described.

### BRIEF DESCRIPTION OF THE DRAWINGS

The disclosure is described by way of example with reference to the following accompanying drawings, wherein:

FIG. 1 shows a local area network in accordance with an embodiment of the present invention;

FIG. 2 shows a local area network implementing redundancy between two OLTs in accordance with an embodiment of the present invention;

FIG. 3 shows a local area network implementing redundancy between two OLTs in accordance with an embodiment of the present invention;

FIG. 4 shows a flowchart for a method for implementing redundancy in accordance with an embodiment of the present invention; and

FIG. 5 shows a state diagram for implementing redundancy in accordance with an embodiment of the present invention.

### DETAILED DESCRIPTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Some portions of the detailed descriptions which follow are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The present disclosure can relate to an apparatus for performing one or more of the operations described herein. This apparatus may be specially constructed for the required purposes such as an application specific integrated circuit (ASIC), or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing information in a form readable by a machine (e.g., a computer). For example, a machine-readable medium includes read only memory (“ROM”); random access memory (“RAM”); magnetic disk storage media; optical storage media; flash memory devices; etc.

At least certain embodiments of the present disclosure include one or application programming interfaces (API) or drivers in an environment with user interface software interacting with a software application. Various function calls or messages are transferred via the application programming interfaces between the user interface software and software applications. Transferring the function calls or messages may include issuing, initiating, invoking or receiving the function calls or messages. Example application programming interfaces transfer function calls to implement scrolling, gesturing, and animating operations for a device having a display region. An API may also implement functions having parameters, variables, or pointers. An API or driver may receive parameters as disclosed or other combinations of parameters. In addition to the APIs or drivers disclosed, other APIs or drivers individually or in combination can perform similar functionality as the disclosed APIs or drivers.

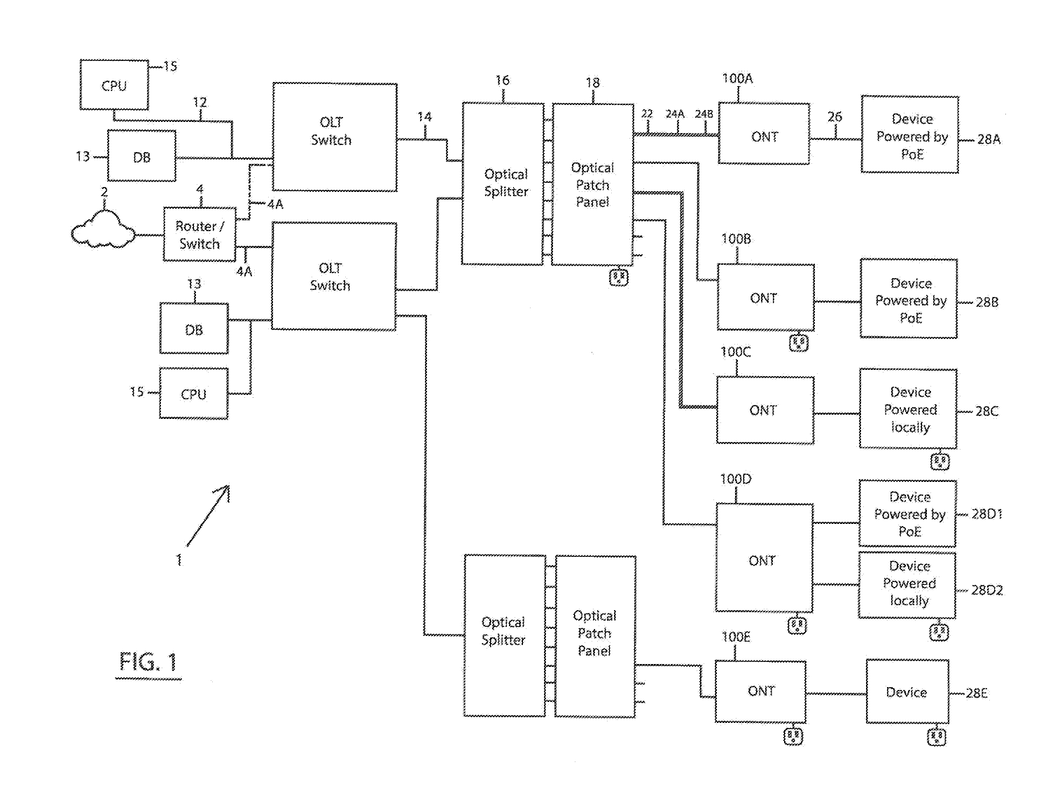

FIG. 1 illustrates a local area network 10 (LAN) using fiber optic connections in accordance with an embodiment of the present invention. The LAN 10 includes an optical line terminal 12 (OLT), optical splitter 16, and optical network terminal 100 (ONT) (shown in FIG. 1 as ONT 100A-100E). The OLT is coupled to the optical splitter 16 by a first fiber optic connection 14. Furthermore, the passive optical splitter is coupled with the ONT 100 using a second fiber optic connection 22.

The OLT 12 may be connected to one or more processors (illustrated as CPU 15) and a database (shown as DB 13). In some embodiments, the CPU 15 and DB 13 may be integrated with the OLT 12.

The LAN 10 may be connected to external networks 2, such as the internet. In some embodiments a router/switch 4 may be used. In a preferred embodiment, this may take the form of an external switch 4 which allows the two OLTs 12 to communicate with each other over an Ethernet connection.

The ONT 100 is coupled with a peripheral device 28 (seen in FIG. 1 as peripheral devices 28A-28E). Peripheral devices 28A-28E may include any number of types of devices for inclusion within LAN 10. For example, a peripheral device 28 may include a computer, a printer, a server and the like. In a preferred embodiment, the peripheral device 28 may be a camera, such as a security camera, connected in a LAN 10 which is designed to provide security coverage of a building, area and the like.

In some embodiments, an Ethernet cable (not shown) of the peripheral device 28 may be used to couple the peripheral device 28 to the ONT 100 over an Ethernet standard. For example, if the peripheral device is network enabled, the ONT 100 may connect to the peripheral device through the peripheral device's network jack.

In other embodiments, the ONT may be incorporated directly into the peripheral device 28. For example, a network interface card (not shown) or proprietary connector and the like may be installed in the peripheral device 28 for coupling the ONT 100 to the peripheral device 28. For example, a small form-factor pluggable transceiver (SFP) may be used. In this manner, the ONT 100 may be installed directly in the peripheral device 28 and may be operable to communicate with the peripheral device 28 over a bus (not shown) or other communication channel, as known in the art.

The OLT 12 is in communication with the ONT 100 using a passive optical networking (PON) standard. As known in the art, a passive optical network (PON) is a point-to-multipoint network architecture which uses passive (i.e. unpowered) optical splitters to connect to peripheral devices 28 over optical fiber. In this manner, an OLT 12 is operable to enable a single optical fiber to serve multiple peripheral devices 28. Typical PON implementations have between 16-128 peripheral devices 28. Architectures utilizing a PON reduce the amount of fiber and related infrastructure required to connect network in comparison to point-to-point architectures.

Any suitable version of a PON standard may be used. For example, the PON standard may be the Gigabit Passive Optical Networks (GPON) standard developed by the International Telecommunication Union (ITU) or the Ethernet Passive Optical Networks (EPON) standard developed by the Institute of Electrical and Electronics Engineers (IEEE). Other flavours of PON such as APON, 10G-PON, 10G-EPON, SPON and the like may also be used.

Packets may be passed in the LAN 10 amongst the peripheral devices 28. In this manner, the OLT behaves as a layer 2 (L2) switch (i.e. data link layer) in the Open Systems Interconnection (OSI) model, while providing the benefits of an optical infrastructure including long reach, smaller and lighter cables, fewer cables, and resistance to lightning and electrostatic discharge (ESD).

In addition, using an OLT 12 with fiber optic transmission paths to implement the LAN 10 is desirable in that optical fiber is expected to become cheaper than unshielded twisted pair (UTP) cabling, as the cost of metals and other natural resources required by Ethernet cabling and the like increases.

As also shown in FIG. 1, the LAN 10 may include a powered patch panel 18 or unpowered patch panel 20 coupled to the passive optical splitter 16. The patch panels 18/20 may be coupled between the passive optical splitter 160 and one or more of the ONT 100. The patch panels 18/20 are configured to allow a plurality of ONT 100 to be plugged and unplugged into the LAN 100 over a plurality of second fiber optic connections 22.

In other embodiments, a patch panel 18/20 is not required. ONTs 100 may be directly connected to the optical splitter 16 without requiring a patch panel 18/20.

### Data Collector

In a preferred embodiment, the PON system 1 may include an analytical engine to run analytics on the network. The analytics may improve the functioning on the PON system 1. For the analytics to run, a networking data collector be created to collect and store network information available in the PON system. For example, a PON system 1 incorporating a data collector may include an optical line terminal (OLT 12), a passive optical splitter 16 and at least one optical networking terminal (ONT 100).

In a preferred embodiment, there may be one or more means for obtaining and storing network information from the at least one optical networking terminal 100. For example, there may be a processor 15 or standalone computer or server capable of collecting and storing the network information. For example, the server may have a database 13 or other software for storing the information. In larger systems, a cloud-based solution may be used to gather and store the network information. The information may be stored in a proprietary or open source database 13.

In a preferred embodiment, the network information may be for each device at a particular ONT 100. The network information may include destination address, source address, timing, amount of traffic, link-speed, timing, and traffic direction. The network information may be some combination of these attributes.

In other embodiments, the networking data collector return transit time (RTT), received signal strength indicators (RSSI), transmitted signal strength indicators (TSSI), current bias of the laser, temperature, and laser drift. In certain embodiments one or more combinations of parameters may be used.

### Analytics

Using data collected and stored by the data collector, the PON system may include an analytics engine capable of extracting useful insights from the data collected. In a preferred embodiment, an analytics engine may include a passive optical network, means for collecting networking information from components in the passive optical network, identifying patterns in the network information and notifying a user based on the patterns identified.

### Analytics—PON Patterns

Different types of patterns can be extracted from the data collected. In a preferred embodiment, the pattern is based on at least one of destination address, source address, timing, amount of traffic, link-speed, timing, and traffic direction. In other embodiments, the pattern is based on PON parameters. For example, in some embodiments, the patters may be based on return transit time (RTT), received signal strength indicators (RSSI), transmitted signal strength indicators (TSSI), current bias of the laser, temperature, and laser drift.

### Analytics—Device Signatures

In a preferred embodiment, a device signature for each device in the network may be created. For example, the device signature may be based on heuristics comprising data taken from many devices of the same model or type. In others, the device signature may be based on one or more of traffic profile, power profile and communication peers. A communication peer may be a similar device such as a camera, sensor and the like. Device signatures may also be formed by one or more combinations of parameters. In a preferred embodiment, the device signature may be formed from traffic profile including the ratio of up/down traffic.

### Analytics—Device Failures

In a preferred embodiment, the analytics engine may identify a pattern that can be used predict a device failure. For example, the pattern for device failure may be based on packet loss or timing. In some embodiments, the analytics engine identifies the pattern for device failure is based on drifts in power consumption. In others, the pattern for device failure is based on a learning pattern of behaviour. In a most preferred embodiment, the pattern for device failure is based on a combination of a learning pattern of behaviour and rules set by a device manufacturer. The learning pater may use both heuristics and machine learning. The learning pattern may include at least one of time of day, seasonal changes, a weather almanac, business hours, and other forms of periodicity.

### Analytics—Network Intrusions

The analytics engine may be used to identify security threats. Users can be notified of the threats in real time using messaging services. Intrusion detection may be quick based on or more packets. In other embodiments, learned behaviour is required and it may take time for a network intrusion to be detected by the analytics engine.

In a preferred embodiment, the pattern identifying the network intrusion is due to a change in MAC address. In others, a change in power consumption or a change in traffic profile indicates a threat to the PON system. Furthermore, the change in traffic profile may include changes in reporting time, length, payload size and traffic behaviour.

The analytics engine may identifies a pattern for learning and tracking device behaviour over time. Sometimes, the pattern for a camera changes in response to commands sent to the camera. For example, a command to point, tilt, and zoom a camera may lead a camera to actualize the command. Such actualization may lead to changes in power consumption, which may be measured by the PON system.

In a preferred embodiment, the analytics engine identifies a signature for every packet in the networking system. Or, the analytics engine may identify a signature for every port in the networking system. Signatures for every device in the networking system may also be used or signatures for every ONT in the networking system.

### Redundancy

Uptime is an important part of a networking system. This is particular true in a building network, where devices connected directly deal with tenant comfort and building efficiency. In a preferred embodiment, redundancy may be accomplished between two OLT 12, without requiring a direct connection or heartbeat between the first and the second OLT 12.

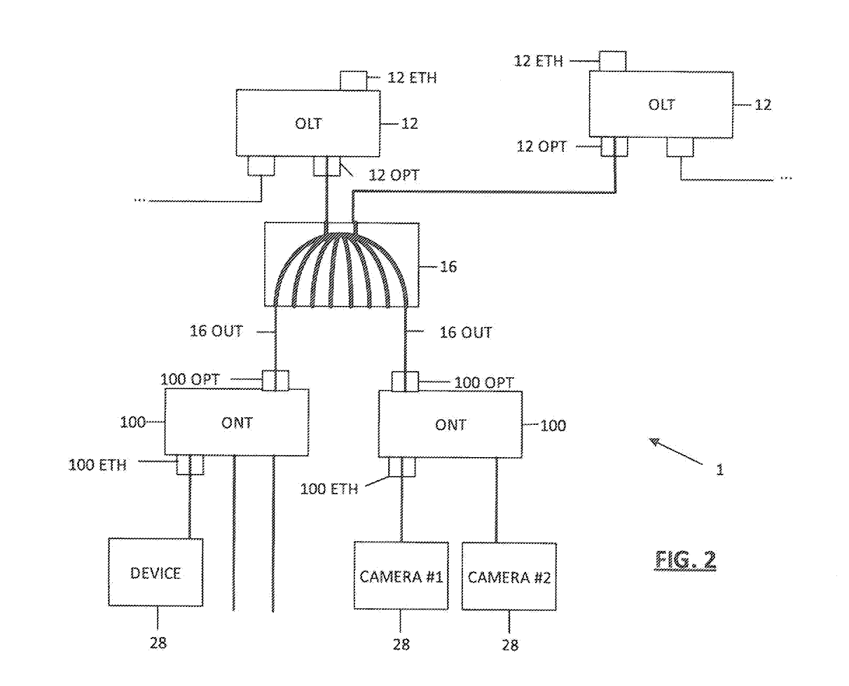

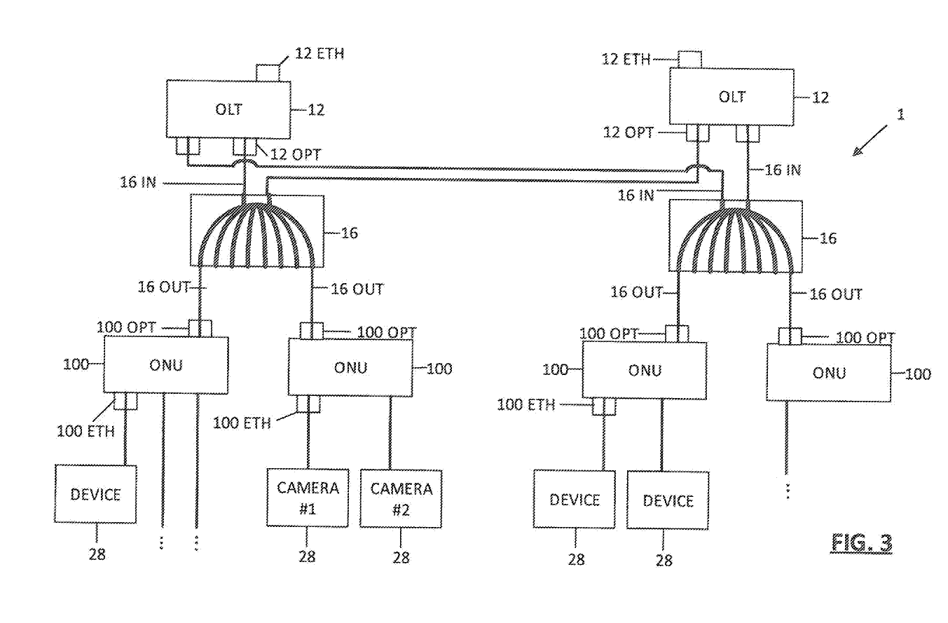

Such a system such as shown in FIGS. 2 and 3 may include a first optical line terminal (OLT 12), a second OLT 12, a two-to-many passive optical splitter 16 and at least one optical networking terminal (ONT 100). The first and the second OLT 12 may each include an Ethernet port 12ETH and an optical port 12OPT having a transmit function and a receive function.

The ONT 100 may also include an optical port 100OPT and at least one Ethernet port 100ETH. Devices 28 within the building network would then be connected to the Ethernet ports 100ETH on the ONT 100. Devices may include cameras, building automation system devices and the like.

The passive optical splitter 16 includes two inputs 16IN and multiple outputs 16OUT. The first optical input 16IN is optically coupled to the first optical port 12OPT of the first OLT 12. The second optical input 16IN is optically coupled to the first optical port 12OPT of the second OLT 12. The first optical output 16OUT of the passive optical splitter 16 is optically coupled to the optical port 100OPT of the ONT 100.

In operation, the ONT 100 may be registered with either the first OLT 12 or the second OLT 12 using a PON standard, as is known in the art. In operation, one of the OLT 12 will be in an ACTIVE state to pass traffic between the ONT 100 and the OLT 12 and the other OLT 12 will be in a PROTECT state or redundancy mode. The second OLT 12 has the transmit function of the first optical port 12OPT turned off. However, the second OLT 12 leaves the receive function of the first optical port 12OPT enabled such that it can listen to communications of the ONT 100 which travel upstream to both the first and the second OLT 12 through the passive optical splitter 16. Any signal which travels upstream through any of the outputs 16OUT of the passive optical splitter 16, travel through both optical inputs 16IN. Similarly, any signal which travels down through either the first input 16IN or the second input 16IN of the passive optical splitter is sent to all optical outputs 16OUT of the passive optical splitter 16. In this manner, the second OLT 12 may listen to the communications between the first ONT 100 (or any ONT 100) and the first OLT 12, without interfering with their communications.

In certain situations or failures, the communication between the first OLT 12 and one or more ONT 100 may be interrupted. For example, if there is a cable cut between the first input 16IN of the passive optical splitter 16 and the first OLT 12 or if the first optical port 12OPT of the first OLT 12 is faulty, then communication between the ONT 100 and the first OLT 12 will be interrupted. If this occurs, the second OLT 12 no longer receives a signal to indicate that the first OLT 12 is still registered or communicating with the first ONT 100. In this situation, the second OLT 12 may turn on the transmit function of the first optical port 12OPT knowing that the first OLT 12 is no longer registered with the ONT 100 and force the ONT 100 to register with the second OLT 12.

In this manner, the PON system 1 can implement redundancy with the second OLT 12 taking over communications with the ONT 100. If the databases 13 are synced between the first OLT 12 and the second OLT 12, the ONTs 100 will be properly registered and configured during the registration process with the second OLT 12. Syncing is required between the first OLT 12 and the second OLT 12 to ensure any network configurations are consistent between the first OLT 12 and the second OLT 12. If not, when a takeover occurs, the network pathways will not allow for the proper configuration of the redundant network. For example, configuration information may include VLAN information, port information, port enabled information, ONU information and communication information.

To initiate the takeover procedure, a signal must be created to indicate to the second OLT 12 that it should take over. In a preferred embodiment, the signal indicating to the second OLT 12 that the first OLT 12 is no longer registered with the first ONT 100 is a received signal strength indicator. When the received signal strength indicator falls below a threshold for a certain period of time, the second OLT 12 can assume that the first OLT 12 is no longer registered with the first ONT 100 and may turn on the transmit function of the first optical port 12OPT to take over. The ONTs 100 that were previously registered with the first OLT 12 can now register with the second OLT 12 and traffic can resume passing through the PON system 1.

The receive function on the optical port of the second OLT 12 may be configured to obtain an absolute measurement of different values. For example, the receive function may take a reading from the RSSI of a single ONT 100. If this single ONT 100 is no longer registered, the second OLT 12 may consider that a failure condition has occurred and use this as a signal that a takeover is required. In alternative embodiments, a combination of the RSSI from many or all of the registered ONT 100 for that optical port 12OPT can be used. In this manner, the second OLT 12 is not reliant on the RSSI of a single ONT 100 and a takeover only occurs if all of the ONT 100 optically coupled to the optical port fail. In other words, the second OLT 12 will only initiate takeover proceedings if the optical port 12OPT of the first OLT 12 is no longer optically coupled or registered to any ONT 100. In this manner, the PON system 1 can ensure that there is a systemic failure requiring a redundancy takeover and not a problem caused by a single ONT 100.

In another preferred embodiment, the second OLT 12 may wait for an extended period of time to ensure the RSSI reading obtained by the second OLT 12 indicates that no ONT 100 are still registered with the first OLT 12. For example, a period of 10 seconds to a minutes, with a preferred time between 20 and 30 seconds, may be enough for the second OLT 12 to decide that the first OLT 12 is no longer receiving any signal from any ONT 100. Only once this period of time has passed with no RSSI reading above the threshold will a takeover procedure occur. In this way, the second OLT 12 may takeover for the first OLT 12 with no direct communication with the first OLT 12. Instead, a period of low RSSI below a threshold is used to indicate to the second OLT 12 to begin the takeover procedure.

When the second OLT 12 takes over, any traffic previously passing from the first or any ONT 100 through the first OLT 12 and through the external switch 4 is now rerouted after the takeover through the second OLT 12 and then through the external switch 4. This process enables redundancy between the two OLT 12. As mentioned, the first OLT 12 and the second OLT 12 do not require any direct communication for the second OLT 12 to takeover when a failure in the first OLT 12 occurs. A failure may include the first optical port 12OPT of the first OLT 12 failing or a cut in the optical fibre between the first OLT 12 and the first ONT 100.

In some embodiments, a direct Ethernet link 4A between the first OLT 12 and the second OLT 12 allows the handover to occur immediately after the signal indicating the first OLT 12 is registered with the first ONT 100 is no longer received. When contacted by the second OLT 12, the first OLT 12 can determine whether communication to the ONT 100 has been lost and, if so, tell the second OLT 12 to immediately take over.

In a preferred alternate embodiment, the first OLT 12 and the second OLT 12 may be connected together via an external switch 4 to improve upon the redundancy performance. Rather than wait for the timeout period to expire, a direct connection 4A between the first OLT 12 and the second OLT 12 may hasten the takeover by the second OLT 12. When the received signal strength indicator falls below the threshold, the second OLT 12 can query the first OLT 12 about whether communications to the ONT 100 has been lost. If so indicated, the first OLT 12 can indicate this to the second OLT 12 and hasten the takeover without waiting for the timeout period. This may improve the task of a takeover by reducing the required time to ensure the takeover occurs correctly. In an alternate embodiment, a mixture of a timeout period and a communication request and acknowledgement to force a takeover may improve the performance of the takeover procedure.

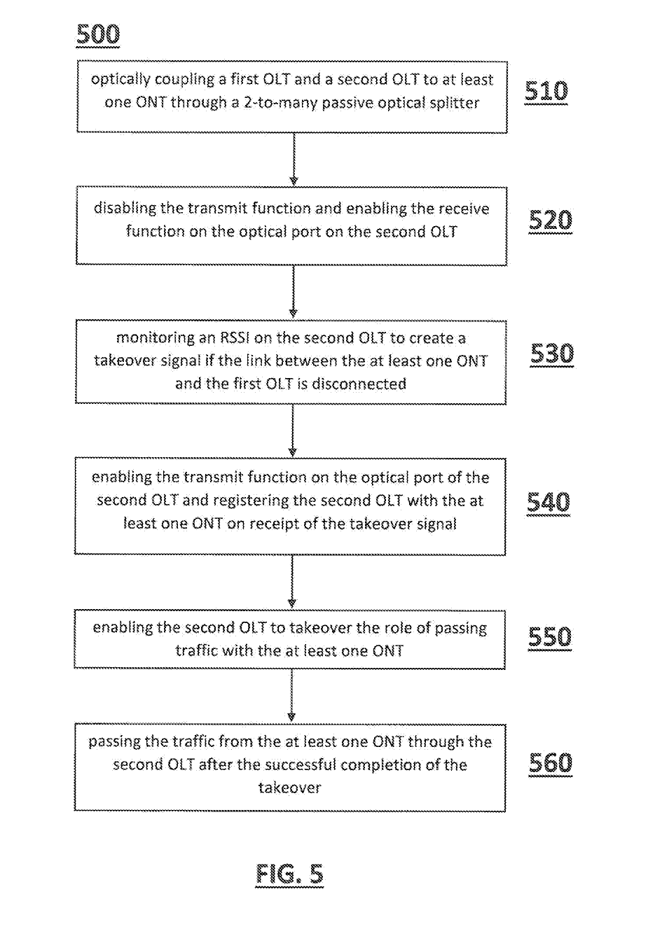

In operation in at least one embodiment of the present invention, the invention resides in a method for implementing redundancy in a passive optical network as shown in FIG. 5. As shown in BLOCK 510, the method 500 may include optically coupling a first optical line terminal (OLT) and a second OLT to at least one optical networking terminal (ONT) through a two-to-many passive optical splitter. Any number of splits output splits may be used so long as there is adequate amount of optical power at the output of the passive optical splitter to allow an ONT to register with the OLT.

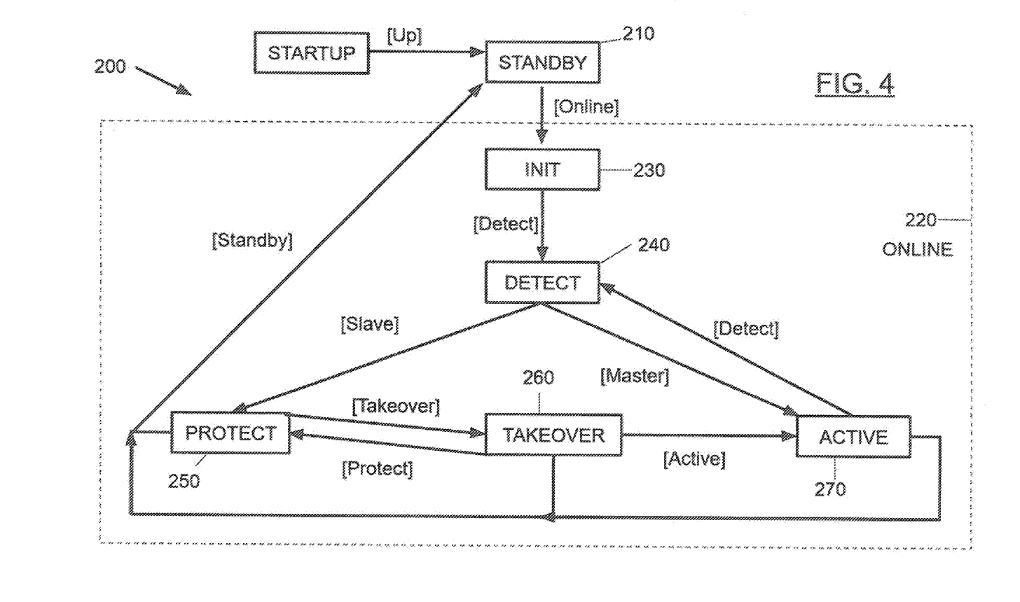

In operation, the first OLT is optically coupled to the first input of the passive optical splitter and the second OLT is optically coupled to the second input of the passive optical splitter. In this manner traffic can theoretically flow between the first OLT and the ONT or the second OLT and the ONT. As shown in FIGS. 3 and 4, no traffic can flow directly from the first OLT and the second OLT through an optical channel as the passive optical splitter only allows traffic to flow in an upstream or downstream direction, with traffic passing from the one or more ONT through either the first OLT or the second OLT.

At any time, the ONT is only capable of registering and passing traffic with a single OLT. However, since both the first and the second OLT are optically coupled or connected with the ONT and thereby capable of registering with the ONT, one of the OLT must be disabled or prevented from registering or communicating with the ONT so as to not affect the behaviour of the ONT and the other OLT. In order to accomplish this, when the ONT is registered and communicating with the first OLT, the transmit function of the optical port on the second OLT must be disabled as shown in BLOCK 520. In this manner no light from the second OLT is able to interfere with the normal operation of the first OLT and the one or more ONT that the first OLT is registered and communicating with.

At the same time, it may be desirable to enable the receive function of the optical port on the second OLT. In this manner, the second OLT is capable of monitoring the communication between the one or more ONT and the first OLT without interfering with the operation or communication of the one or more ONT registered with the first OLT. It can then use this capability for monitoring purposes.

In BLOCK 530, the second OLT may monitor the received signal strength indicator (RSSI) on communications from the one or more ONT to the first OLT. The second OLT may use this information to create a takeover signal if the link between the at least one ONT and the first OLT is broken. For example, the RSSI may drop below a minimum threshold if no ONT are registered with the first OLT or if the fibre between the one or more ONT and the first OLT is broken. In a preferred embodiment, the minimum threshold is less than −25 dBm. In another preferred embodiment, the RSSI minimum is at the most −30 dBm. Such may be the case if this is a fiber cut between the one or more ONT and the first OLT.

In a preferred embodiment, the takeover signal may include waiting for the RSSI to be below a minimum threshold for a predetermined period of time. For example, the predetermined period of time may be between 10 and 30 seconds. However, other time periods may be used to increase reliability or for faster switchovers.

While not necessary, the takeover signal in BLOCK 530 may further include an acknowledgement message from the first OLT to the second OLT to initiate the takeover role. In a preferred embodiment, this acknowledgement message may be in direct response to a request from the second OLT. For example, upon the completion of the predetermined period of time of low RSSI, the second OLT may ask the first OLT whether it has lost communications with the at least one ONT. If the first OLT responds in the affirmative, the second OLT may then generate the takeover signal and initiate the takeover

On receipt of the takeover signal as shown in BLOCK 540, the second OLT may enable the transmit function of its optical port. In this manner, it may be enabled to both transmit and receive information through its optical port.

Furthermore, the second OLT may be enabled to now register with the at least one ONT as shown in BLOCK 550. Once registered with the at least one ONT, the second OLT will then be capable of passing traffic with the at least one ONT through the passive optical splitter.

Finally, as shown in BLOCK 560, the second OLT has assumed control of passing the traffic from the at least one ONT. Because of the failure in the communication path between the first OLT and the at least one ONT, a takeover has successfully occurred where traffic is now enabled to continuing flowing through the second OLT. If the first and second OLT are communicatively coupled to an external switch through their respective Ethernet ports, this traffic can continue to flow upon the successful takeover. In this manner, the second OLT is configured to takeover handling all of the traffic from the first OLT, if the first OLT fails or a fibre cut occurs between the optical port of the first OLT and one of the two inputs of the passive optical splitter which is optically coupled to the first OLT.

In operation in at least one additional embodiment of the present invention, a state machine may be configured on each OLT 12 to maintain which OLT is operating to pass traffic from the connected and registered ONTs 100. A state machine 200 in accordance with one embodiment of the present invention is shown in FIG. 4. The state machine 200 is configured to operate the redundancy checks required to place and keep the first OLT 12 and the second OLT 12 into their respective states. When there are multiple optical channels for each OLT 12, a single state machine 200 may be used for both or all optical channels. In some embodiments, the state machine 200 covers the operation of multiple optical channels and a takeover occurs if a failure is detected in a single optical channel 12OPT. In alternate embodiments, a separate state machine 200 may be used for each channel. As known in the art, each optical channel corresponds to a separate optical port 12OPT. In the following description, reference to a specific OLT 12 refers to a specific optical port 12OPT on the OLT 12. It should be understood that where there are multiple optical ports 12OPT, the following references to first OLT 12 and second OLT 12 should make reference to their respective or specific optical ports 12OPT.

As seen in FIG. 4, the state machine includes a STANDBY 210 state and an ONLINE 220 state. The STANDBY state is used after initial STARTUP to ensure that the OLT 12 does not immediately shine a laser when entering the ONLINE state. Otherwise, this may interfere with the operation of a second OLT 12 already in operation. The ONLINE state is composed of further sub-states INIT 230, DETECT 240, PROTECT 250, TAKEOVER 260 and ACTIVE 270.

When the first OLT 12 (i.e. an optical port 12OPT on the first OLT 12) is registered with ONT 100 over the optical port 12OPT, it is considered to be in the ACTIVE state. An OLT 12 in the ACTIVE state is fully functioning and is configured to register and to pass traffic with an ONT 100. An OLT 12 in the ACTIVE state is capable of operating normally within a PON system.

When a second OLT 12 (i.e. an optical port 12OPT on the second OLT 12) is listening to the activity of the first OLT 12 and the ONT 100, the second OLT 12 is considered to be in the PROTECT state. An OLT 12 in the PROTECT state has the OLT's transmit function disabled. However, it is still capable of receiving light from the optically coupled ONTs 100. When in the PROTECT state, the second OLT 12 is not transmitting through the optical port 12OPT; instead, it is only receiving information in the DETECT state such as the RSSI of the one or more ONT 100, and measuring the RSSI to indicating when a failure occurs. When a failure occurs a takeover signal will be generated and push the OLT 12 into the TAKEOVER state.

In operation, the second OLT 12 in the PROTECT state may be continuously monitoring the RSSI of the ONT 100 connected to the optical port 12 OPT. If the second OLT 12 determines that the RSSI falls below a threshold, the second OLT 12 may begin counting using a timer. This may be within the PROTECT state itself or cycling through a number of states as shown in FIG. 4. If the RSSI is below the threshold for a pre-determined period of time, the second OLT 12 may start the takeover process by moving into the TAKEOVER state. As discussed above, this may include sending a message to the first OLT 12 to see if the first OLT 12 is still there. A response from the first OLT 12 may include a message not to take over. Alternatively, the response from the first OLT 12 may include a message to hasten takeover. If this occurs, the second OLT 12 may initiate the takeover process and enable the transmit function of its optical port 12OPT. Once enabled, the second OLT 12 may then register with all the ONT 100 that it is optically coupled with.

In alternate embodiments, the second OLT 12 may receive no message from the first OLT 12. This may occur if the first OLT 12 has lost power or has otherwise crashed or is unresponsive. In these situations, the second OLT 12 may wait for a predetermined period of time before taking over communication with the ONT 100. During this predetermined period of time, the second OLT 12 may continue to request a response from the first OLT 12, in case the first OLT 12 comes out of its indeterminate state.

In the foregoing specification, the disclosure has been described with reference to specific exemplary embodiments thereof. It will be evident that various modifications may be made thereto without departing from the broader scope of the disclosure as set forth in the following claims. The scope of the claims should not be limited by the preferred embodiments set forth in the examples, but should be given the broadest interpretation consistent with the description as a whole. The specification and drawings are, accordingly, to be regarded in an illustrative sense rather than a restrictive sense.

1. A passive optical networking (PON) system comprising:
a first optical line terminal (OLT) including
at least one Ethernet port;
a first optical port having a transmit function and a receive function;
a second optical line terminal including
at least one Ethernet port;
a first optical port having a transmit function and a receive function;
a first optical networking terminal (ONT) including an optical port and at least one Ethernet port;
a first passive optical splitter including:
a first optical input optically coupled to the first optical port of the first OLT;
a second optical input optically coupled to the first optical port of the second OLT; and
a plurality of optical outputs, wherein a first optical output is optically coupled to the optical port of the first ONT; and
wherein the first OLT cannot directly communicate with the second OLT through the first passive optical splitter;
wherein the first ONT is registered with the first OLT and the second OLT has the transmit function of the first optical port turned off, but the receive function turned on and is listening to the communication from the first ONT to the first OLT; and
when the second OLT no longer receives a signal indicating that the first OLT is still registered with the first ONT, the second OLT turns on the receive function of the first optical port and registers with the first ONT to allow the flow of traffic from the first ONT to the second OLT.

2. The PON system of claim 1, wherein the signal indicating the first ONT is still registered with the first OLT is a received signal strength indicator (RSSI).

3. The PON system of claim 2, wherein when the RSSI falls below a threshold for a predetermined period of time, the second OLT knows that the first OLT is no longer registered with the first ONT and turns on the transmit function of the first optical port of the second OLT to take over communications with the first ONT.

4. The PON system of claim 3, wherein the first OLT and the second OLT are connected together via an external switch such that when the second OLT takes over communication with the first ONT, any traffic previously passing from the first ONT through the first OLT and through the external switch is now rerouted after the takeover through the second OLT and then through the external switch.

5. The PON system of any one of claim 1, wherein the first OLT and the second OLT do not require any direct communication for the second OLT to takeover when a failure in the first OLT occurs.

6. The PON system of claim 5, wherein the failure includes at least one of the first optical port of the first OLT failing and a cut in the optical fibre between the first OLT and the first ONT.

7. The PON system of claim 4, wherein an Ethernet link between the first OLT and the second OLT allows the handover to occur quickly after the signal indicating the first OLT is registered with the first ONT is no longer received.

8. The PON system of claim 7, wherein the second OLT requests a takeover from the first OLT when the signal indicating the first OLT is registered with the first ONT is no longer received.

9. A method for implementing redundancy in a passive optical network, the method comprising:
optically coupling a first optical line terminal (OLT) and a second OLT to at least one optical networking terminal (ONT) through a two-to-many passive optical splitter, the first OLT optically coupled to the first input of the passive optical splitter and the second OLT optically coupled to the second input of the passive optical splitter, with traffic passing from the at least one ONT through the first OLT;
disabling the transmit function and enabling the receive function on the optical port of the second OLT;
monitoring the received signal strength indicator (RSSI) on the second OLT to create a takeover signal if the link between the at least one ONT and the first OLT is disconnected;
enabling the transmit function on the optical port of the second OLT and registering the second OLT with the at least one ONT on receipt of the takeover signal;
enabling the second OLT to takeover the role of passing traffic with the at least one ONT, from the first OLT; and
passing the traffic from the at least one ONT through the second OLT after the successful completion of the takeover.

10. The method of claim 9, wherein the takeover signal includes waiting for the RSSI to be below a minimum threshold for a predetermined period of time.

11. The method of claim 10, wherein the predetermined period of time is between 10 and 30 seconds and the minimum threshold is at the most −30 dBm.

12. The method of claim 10, wherein the takeover signal further includes an acknowledgement message from the first OLT to the second OLT to initiate the takeover role.

13. The method of claim 9, wherein the disabling of the transmit function of the optical port of the second OLT prevents the second OLT from interfering with the normal operation of the at least one ONT and the first OLT.

14. A state machine for implementing redundancy in a passive optical network having an optical line terminal (OLT) with multiple optical channels, the state machine comprising:
an ACTIVE state to allow the OLT to register with at least one optical line terminal (ONT) and to pass traffic with the at least one ONT under normal operation;
a PROTECT state to continuously monitor the RSSI of the at least one ONT connected to a different OLT in the ACTIVE state, where in the OLT in the PROTECT state has disabled its transmit capabilities and has enabled its receive capabilities; and
a STANDBY state is used after initial STARTUP to ensure that the OLT does not immediately shine a laser and interfere with the different OLT in the ACTIVE state.

15. The state machine of claim 14, wherein the state machine is coupled to one of the multiple optical channels, and each of the multiple optical channels has an independent state machine.
